(19) United States
(12) Patent Application Publication
(10) Pub. No.: US 2003/0128718 A1
(43) Pub. Date: Jul. 10, 2003

(54) Method for switching and routing large bandwidth continuous data streams from a centralized location

(76) Inventors: Paul J. Matthews, Ellicott City, MD (US); Paul D. Biernacki, Fairfax, VA (US); Irl N. Duling, Lancaster, PA (US)

Correspondence Address: PILLSBURY WINTHROP, LLP, P.O. BOX 10500, MCLEAN, VA, 22102, US

(21) Appl. No.: 10/267,045

(22) Filed: Dec. 20, 2002

Related U.S. Application Data
(60) Provisional application No. 60/327,779, filed on Oct. 10, 2001.

(51) Int. Cl. H04J 1/00; H04J 3/04

(52) U.S. Cl. 370/480

(57) ABSTRACT

An arrangement is provided for switching and routing large bandwidth continuous information from a consolidated information distribution center (CIDC). The CIDC generates an optical signal encoded with information of multiple channels carried by one or more dedicated optical carriers and sends the optical signal to a plurality of head ends via an optical fiber. When a head end receives the optical signal, it decodes the optical signal to obtain information intended for the head end from at least one optical carrier that is dedicated to carry the information desired by the head end.

This Application is based on Provisional Application No. 60/327,779 filed Oct. 10, 2001, the entire contents of which is hereby incorporated by reference.

### BACKGROUND

1. Field of Invention

The present invention relates to information distribution architecture and arrangements for transporting information from a central location via an optical fiber.

2. Discussion of Related Art

Currently, many industries such as cable television (CATV), use proprietary hybrid fiber-coax (HFC) architectures to service a given metropolitan area. As technology has evolved, the trend in system design is to consolidate services, equipment, and information, further upstream, to effect savings in space, cost, and maintenance. Previous implementations have most of the information and equipment concentrated at hub sites due to difficulties in distributing the information. In contrast, most current architectures consolidate equipment and information sources (e.g., satellites, video servers, IP routers, or reception antennas) at so called “head end”, “master head end”, or “regional head end”, that are upstream of hubs. Such architectures allow aggregation of resources which subsequently resulted in better efficiency, increased service offerings, and increased revenues for the CATV industry.

Further aggregation of services and information beyond a given metropolitan region is inherently advantageous in light of the continuing demand for information and subsequent capital equipment costs for real-time services such as video on demand. Aggregated information may be typically transported over fiber-optic lines to be broadcast to all linked head ends. One impediment to utilizing this scheme of continued consolidation of equipment and information sources is the requirement of dynamically delivering information to locations (or head ends) where the information is requested in a cost effective manner. Therefore, there is a need for an efficient switching and routing scheme, by which information can be dynamically transported to where it is desired in an efficient and cost effective way.

### SUMMARY

In accordance with the present invention, a method is provided for switching and routing large bandwidth continuous data streams from a centralized location. The centralized location may correspond to a consolidated information distribution center that acquires information from a plurality of sources. To distribute information to a plurality of head ends, the consolidated information distribution center switches the information to appropriate information channels and directs the information encoded in the appropriate information channels to the head ends via an optical transmission fiber.

In a preferred embodiment, the consolidated information distribution center is constructed to direct different information to different head ends using information channels dedicated to each of the head ends. In this preferred embodiment, information requested by a requesting head end is switched or routed to the appropriate information channel(s) dedicated to the requesting head end before the requested information is encoded using the dedicated channel and sent to the head end via the optical transmission fiber.

In a different preferred embodiment, the consolidated information distribution center is constructed to direct broadcast information to different head ends using a broadcast information channel dedicated to the broadcast information. In this preferred embodiment, to distribute broadcast information to all head ends, the broadcast information is switched or routed to the broadcast information channel before it is encoded using the dedicated broadcast information channel and sent to different head ends via the optical transmission fiber.

In another different preferred embodiment, the consolidated information distribution center is constructed to distribute both broadcast information as well as information requested. In this embodiment, the broadcast information is transmitted to different head ends using an information channel dedicated to the broadcast information. The information requested by each individual head end is transmitted to the requesting head end using information channel(s) dedicated to the individual head end.

In yet another different embodiment, the consolidated information distribution center is constructed to direct information to a plurality of head ends via information channels dedicated to the head ends. In this embodiment, one or more information channels may be dedicated to each head end. Information directed to a head end, including both broadcast information and information specifically requested by the head end, is encoded using the information channel(s) dedicated to the head end. With this embodiment, broadcast information is directed to the head ends through all information channels.

In accordance with another aspect of the invention, a head end receiving an optical signal over an optical transmission fiber includes an optical filter designed for receiving information transmitted via information channel(s) dedicated to the head end. The received information includes broadcast information or information specifically requested by the head end. The broadcast information may be transmitted using an information channel dedicated to the broadcast information. The broadcast information may also be transmitted using an information channel that is dedicated to the head end. In the latter case, the broadcast information may be encoded in the information channel together with the information requested by the head end.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts an exemplary consolidated content delivery framework, according to a first embodiment of the present invention;

FIG. 2 depicts an exemplary consolidated content delivery framework, according to a second embodiment of the present invention;

FIG. 3 depicts an exemplary consolidated content delivery framework, according to a third embodiment of the present invention;

FIG. 4 depicts an exemplary consolidated content delivery framework, according to a fourth embodiment of the present invention;

FIG. 5 is an exemplary block diagram of a consolidated information distribution center, according to embodiments of the present invention;

FIG. 6 is an exemplary block diagram of an optical signal generation mechanism, according to embodiments of the present invention;

FIG. 7 is an exemplary block diagram of a quadrature amplitude modulation mechanism;

FIG. 8 is an exemplary block diagram of a frequency division multiplexer;

FIG. 9 shows an exemplary distribution of optical amplifiers along an optical fiber, according to an embodiment of the present invention;

FIG. 10 depicts an exemplary block diagram of a head end, according to embodiments of the present invention;

FIG. 11 is a flowchart of an exemplary process, in which a consolidated content delivery framework sends a single optical signal carrying content data of multiple channels to a plurality of head ends via an optical fiber, according to embodiments of the present invention;

FIG. 12 is a flowchart of an exemplary process, in which a consolidated information distribution center encodes content data of multiple channels to generate a single optical signal, according to embodiments of the present invention; and

FIG. 13 is a flowchart of an exemplary process, in which a head end receives an optical signal from a consolidated information distribution center via an optical fiber and decodes the optical signal to generate content data of multiple channels, according to embodiments of the present invention.

### DETAILED DESCRIPTION

The present invention involves a consolidated information distribution system, wherein a consolidated information distribution center consolidates resources and effectively distributes information, via an optical fiber, to a plurality of head ends. The consolidated resources include information from a plurality of sources, the equipment that are necessary to acquire the information from different sources, the equipment to efficiently encode the information, and the devices to transmit the encoded information. By consolidating the resources conventionally distributed in every head end, the cost associated with information distribution is reduced. When head ends cross regional boundaries, this information distribution scheme also enables consolidated services.

Associated with this consolidated information distribution system is an efficient information switching and routing scheme, which allows head ends, upon receiving an optical signal encoded with information of multiple data streams, to effectively obtain desired information from multiple information channels with reasonable cost.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, computer-readable media may comprise any form of data storage mechanism, including such existing memory technologies as well as hardware or circuit representations of such structures and of such data.

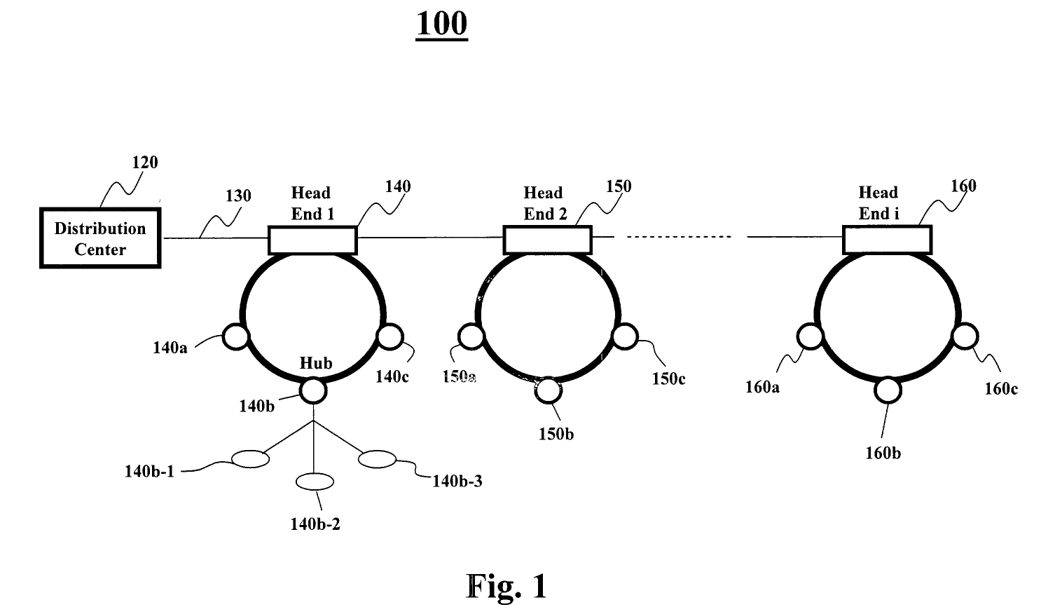

FIG. 1 depicts an exemplary consolidated content delivery framework 100, according to a first embodiment of the present invention. The framework 100 comprises a consolidated information distribution center (CIDC) 120, a plurality of head ends (head end 1 140, head end 2 150, . . . , and head end i 160), and an optical fiber 130 that connects the CIDC 120 and the head ends 140, 150, . . . , 160. The head ends 140, 150, . . . , 160 are connected via the optical fiber 130 in a serial fashion. The CIDC 120 sends content data, encoded as an optical signal, via the optical fiber 130 to the head ends. The optical signal may be a single optical signal that has a plurality of wavelength channels in a wavelength division multiplexed transmission line. It may also include strings of information that have been subcarrier multiplexed. These possible embodiments will be described in more detail below. The optical signal from the CIDC 120 travels along in the direction from the first head end to the last head end. That is, the optical signal reaches the head end 1 140 first, the head end 2 150 second, . . . , and the head end i 160 the last.

Each of the head ends may be a master head end or a regional head end and may include a plurality of hubs. For example, the head end 1 140 includes hubs 140a, 140b, . . . , 140c; the head end 2 150 includes hubs 150a, 150b, . . . , 150c; and the head end i 160 includes hubs 160a, 160b, . . . , 160c. Each head end distributes content data to its own hubs. Each hub under a head end may further include a plurality of nodes. For example, the hub 140b includes three nodes 140b-1, 140b-2, and 140b-3. Each of such nodes may be responsible for distributing content data to a plurality of sites (not shown) which may correspond to residential homes. Different head ends may distribute different contents to their hubs. In addition, each hub may distribute different content to its nodes, and each node may distribute different content to the sites that it is responsible for.

The CIDC 120 consolidates equipment that are necessary for variety of purposes. Content may be acquired from different sources via some network, which may include a proprietary network, a cable network, a satellite network, a wireless network, or the Internet. Different equipment may be required to receive content data from different networks. For example, to receive content from a satellite, one or more satellite dishes may be required. In addition, content may be generated at the CIDC 120. Storage units may be needed to store content and servers may become necessary to manage such storage units. Furthermore, to distribute content to the head ends 140, 150, . . . , 160 via the optical fiber 130, the CIDC 120 also includes equipment capable of encoding content data to generate an optical signal.

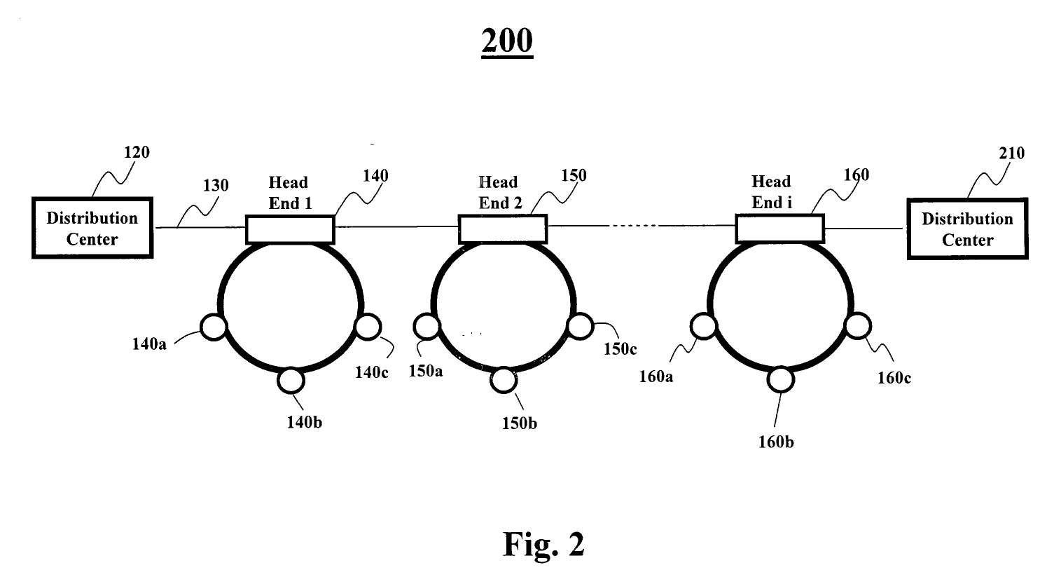

FIG. 2 depicts an exemplary consolidated content delivery framework 200, according to a second embodiment of the present invention. To provide fault tolerance to the framework 100, the framework 200 includes a second CIDC 210, connecting to the linearly arranged head ends 140, 150, . . . , 160 from the opposite end. That is, the CIDC 210 is located closest to the last head end with respect to the CIDC 120. In the depicted embodiment shown in FIG. 2, the CIDC 210 is connected to the end closest to the head end 160.

The CIDC 210 may possess the same capability as the CIDC 120. It may synchronize with the CIDC 120, distributing the same content to the head ends 140, 150, . . . , 160 at the same time. However, the CIDC 210 may acquire, store, and manipulate content independently. For example, the CIDC 210 may have its own satellite dishes, its own storage systems, its own video servers, as well as its own content encoding mechanism. In addition, the CIDC 210 may generate an optical signal based on its own version of the content data (e.g., same content as what the CIDC 120 has) and send its optical signal to the head ends. Furthermore, when the optical signal from the CIDC 210 is sent to the head ends, the optical signal may be sent in an opposite direction as the signal from the CIDC 120. That is, the optical signal from the CIDC 210 travels along the optical fiber 130 in a direction from the head end 160 to the head end 150 and finally to the head end 140.

The framework 200 provides fault tolerance through the CIDC 210. With both the CIDC 120 and the CIDC 210 synchronously distributing the same content data to the head ends, when one of the CIDCs fails to function, the head ends may still receive the encoded content data. This requires that each of the head ends have the capability of receiving content data from both CIDCs and at a certain time determine which optical signal to intercept.

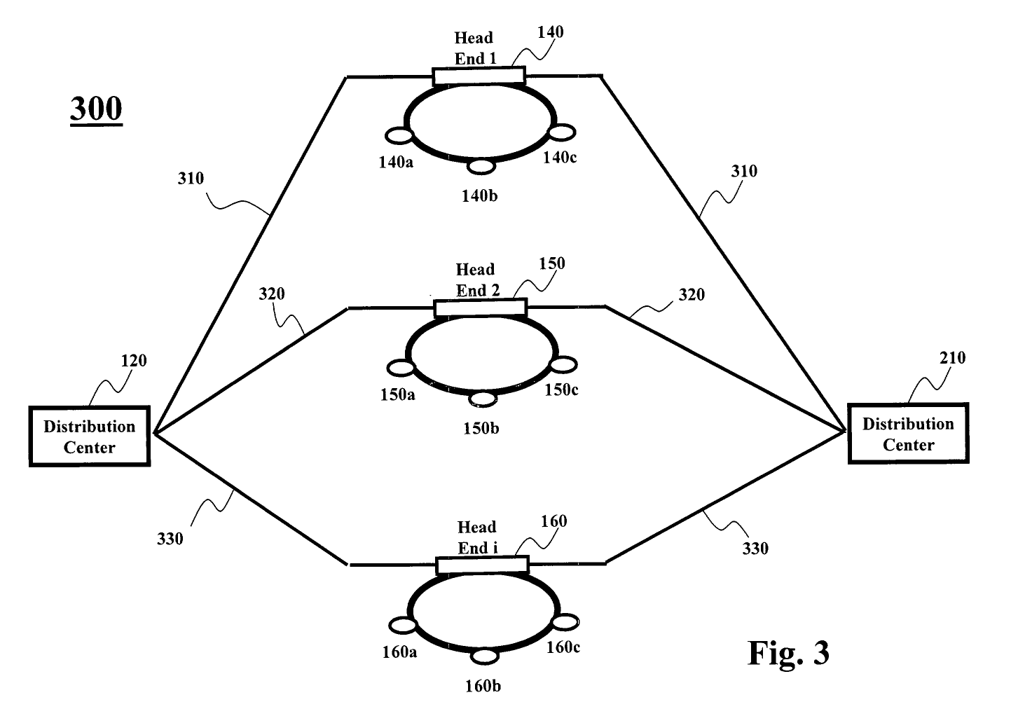

FIG. 3 depicts an exemplary consolidated content delivery framework 300, according to a third embodiment of the present invention. The framework 300 represents an alternative configuration, in which the head ends 140, 150, . . . , 160 are arranged, with respect to the CIDC 120, in a star configuration. Every head end is directly connected to the CIDC 120 via an otical fiber: the head end 1 140 through an optical fiber 310, the head end 2 150 through an optical fiber 320, . . . , the head end i 160 through an optical fiber 330. With this configuration, an optical signal encoding the content data from the CIDC 120 is broadcast to all the head ends through the optical fibers 310, 320, . . . , 330.

Alternatively, the framework 300 may also include a second CIDC 210 to provide fault tolerance. The CIDC 210 connects to the head ends via the optical fibers 310, 320, . . . , 330 and sends its optical signal to the head ends in an opposite direction.

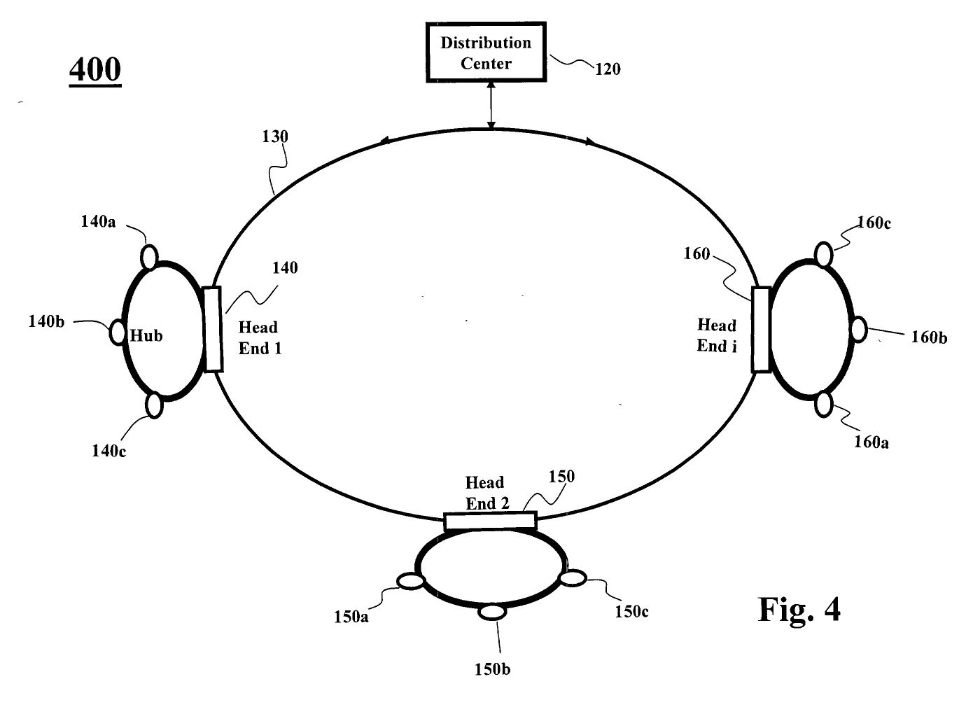

FIG. 4 depicts an exemplary consolidated content delivery framework 400, according to a fourth embodiment of the present invention. The framework 400 represents yet another alternative configuration, in which the head ends 140, 150, . . . , 160 are arranged, with respect to the CIDC 120, in a ring configuration. The head ends 140, 150, . . . , 160 are arranged in a circular fashion and are connected via the optical fiber 130. The CIDC 120 sends an optical signal to the head ends via the optical fiber and the optical signal may be sent along both a clockwise direction and a counter clock direction. Alternatively, the framework 400 may also include a second CIDC (not shown) to provide fault tolerance.

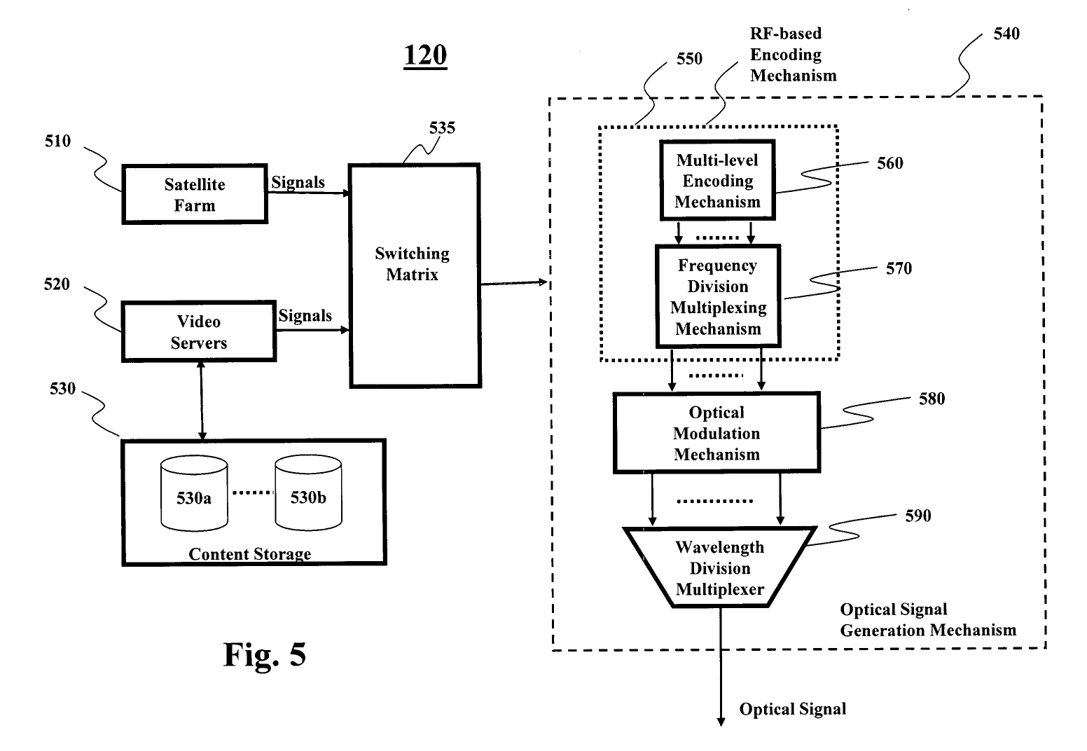

FIG. 5 is an exemplary block diagram of a consolidated information distribution center (e.g., the CIDC 120), according to embodiments of the present invention. The CIDC 120 may comprise, but is not limited to, a satellite farm 510, a video server 520, a content storage unit 530, a switching matrix 535, and an optical signal generation mechanism 540. The satellite farm 510 may include a plurality of satellite dishes (not shown) that intercept signals from satellites. The video server 520 may comprise one or more physical servers that may facilitate different needs in content distribution. For instance, the video server 520 may facilitate video on demand, in which the video server 520 provides content based on what a subscriber requests. The video server 520 may also manage the content storage unit 530.

The content storage unit 530 is used to store content which may be, for example, digital video encoded in MPEG2. The content storage unit 530 may include a plurality of storage devices 530a, . . . , 530b that may be managed by the video server 520. The content stored in the content storage unit 530 may be retrieved dynamically and such content may be broadcast or sent to the head ends 140, 150, . . . , 160 based on demand. The content from either the satellite farm 510 or the video server 520 may correspond to multiple channels and each channel may comprise one or more data streams. For instance, the content intercepted from satellites by the satellite farm 510 may constitute TV broadcast of many channels and content of each channel may further comprise separate data streams such as video, audio, and transcriptions. The content stored in the content storage unit 530 may be organized as such or in other fashions to facilitate efficient data storage and access.

The switching matrix 535 is used to route content to different dedicated channels. Dedicated optical channels may be used to enable a content distribution scheme in which different content may be delivered to different head ends. Such delivery may be based on demand, e.g., video on demand (VoD). Some content may alternatively need to be broadcasted. For instance, news content received from a satellite may be broadcasted to all head ends. Different content delivery schemes may be achieved through dedicated optical channels. The switching matrix 535 facilitates content delivery schemes by routing certain content to pre-determined dedicated optical channels.

Different schemes may be adopted to broadcast content. For example, a particular optical channel may be dedicated for broadcast purposes. To ensure that broadcast content reaches every head end, it may be required that all head ends are equipped to intercept signals corresponding to such broadcast content carried in a dedicated broadcast optical channel. Every head end may receive such a broadcast optical channel. Alternatively, switching matrix 535 may be used to effectively achieve broadcast over optical channels dedicated to particular head ends. To broadcast content using the dedicated optical channel, the switching matrix 535, upon recognizing that the content to be sent is broadcast content, routes the content to the dedicated optical channel for each head end. Here, what constitutes broadcast content may be pre-determined. Alternatively, content can also be distributed to all head ends without using a particular dedicated optical channel. For example, broadcast content may be routed to all available optical channels.

Content may also be distributed based on demand. For example, video data, requested by a user via a particular head end (i.e., the particular head end provides content to the user), may be delivered to the user by using a particular optical channel that is dedicated to the head end. In this case, other head ends, to which the particular optical channel is not dedicated, will not be able to receive the content.

Content may also be routed to different types of carriers, which may include RF carriers or optical carriers. In an encoding scheme described with reference to the optical signal generation mechanism 540, content routed to RF carriers may be eventually up-converted to fixed optical carriers. Content may also be routed directly to optical carriers. For example, video content that is on/off key base band can be transported directly to an optical modulator.

A complex content delivery scheme may be achieved through flexible use of dedicated optical carriers. For example, an optical channel may be dedicated to all or some head ends. Each head end may have one or more optical channel dedicated to it. The switching matrix 535 may be constructed in a manner that is consistent with desired content delivery schemes. In other words, the switching matrix 535 programs a pre-determined content delivery scheme. With the switching matrix 535, content (from both the satellite farm 510 and the video server 520) to be distributed is switched or routed to certain channels that are appropriate according to the pre-determined delivery scheme.

The optical signal generation mechanism 540 takes signals from either the satellite farm 510 or the video server 520 (representing the content to be distributed) and generates a single optical signal as its output to be sent to the head ends 140, 150, . . . , 160 via an optical fiber (FIGS. 1, 2, 3, and 4). The optical signal generation mechanism 540 may generate the optical signal in more than one stage. For instance, input signals may be first modulated in a spectrally efficient manner. Such modulated signals may then be multiplexed onto radio frequency (RF)/microwave sub-carriers. To transmit such encoded content through an optical fiber (e.g., the optical fiber 130), the RF sub-carriers may be further up-converted onto optical carriers, each may be at a different wavelength, and then multiplexed to yield a single optical wavelength division multiplexed signal.

Corresponding to the above-described stages, the optical signal generation mechanism 540 comprises an RF-based encoding mechanism 550, an optical modulation mechanism 580, and a wavelength division multiplexer (WDM) 590. The RF-based encoding mechanism 550 modulates the content signals onto one or more RF/microwave carriers. The RF-based encoding mechanism 550 includes a multi-level encoding mechanism 560 and a frequency division multiplexing (FDM) mechanism 570. The multi-level encoding mechanism 560 may modulate signals corresponding to content from different data streams or channels to yield modulated signals. Modulated signals corresponding to different data streams may be combined through the FDM mechanism 570 that multiplexes modulated signals of different data streams onto a single RF/microwave carrier, yielding a single RF signal.

One or more different RF/microwave carriers of different frequencies may be used to carry modulated signals. When one RF carrier is used, different groups of data streams may be multiplexed onto the same RF carrier of a fixed frequency, yielding different RF signals. When multiple RF carriers are used, different groups of data streams may be multiplexed onto multiple RF carriers of different frequencies. Different content may be routed to different RF carriers according to switching matrix 535. Such generated RF signals carry data streams based on different frequencies.

Each of the RF signals, either carried by RF carriers of the same frequency or different frequencies, can be up-converted onto different optical carriers of different wavelengths. This is achieved through the optical modulation mechanism 580. Specifically, the optical modulation mechanism 580 may include a plurality of optical modulators, each of which up-converts a single RF signal onto an optical carrier of a particular wavelength. Since an RF carrier may carry more than one data stream, these data streams may then be aggregated onto a single optical wavelength. As discussed above, content (e.g., on/off key base band video data) may be routed directly (without being modulated into an RF carrier) to an optical modulator corresponding to a particular wavelength to be encoded.

The optical modulation perform-ed by the optical modulation mechanism 580 yields a plurality of optical signals, carrying multiple data streams. The multiple data streams can be further aggregated to generate a single optical signal. This is achieved through the wavelength division multiplexer (WDM) 590, which takes a plurality of optical channels, carrying the multiple data streams, and multiplexes the optical signals to generate a single optical signal as the output of the CIDC 120 having a plurality of WDM channels.

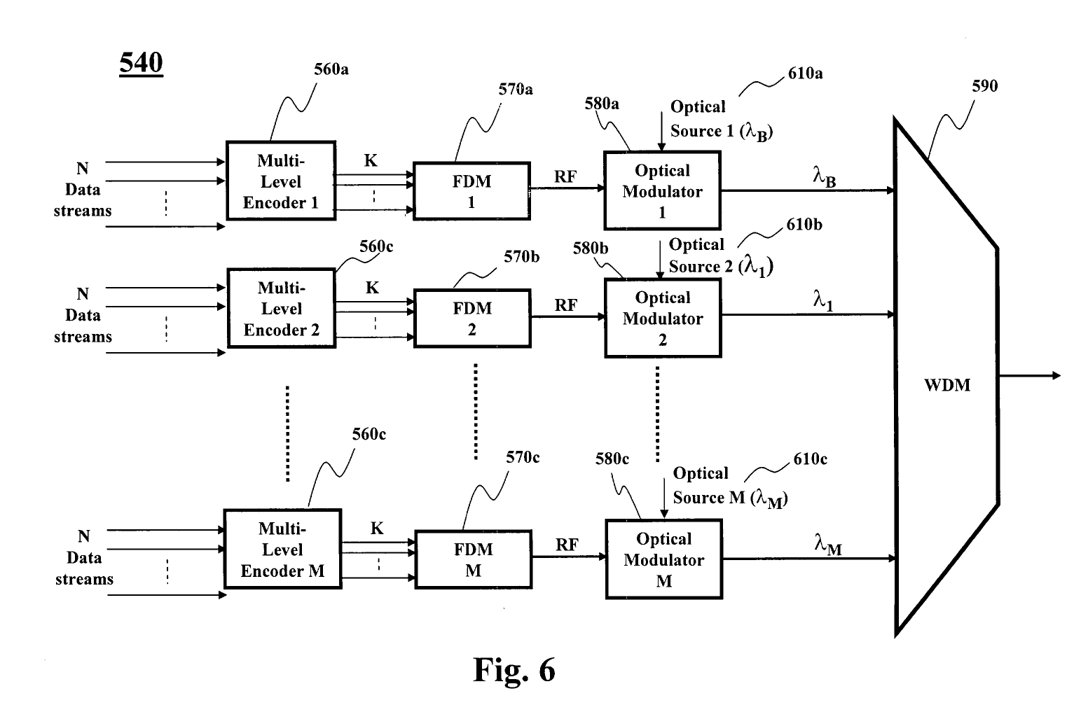

FIG. 6 is a detailed exemplary block diagram of the optical signal generation mechanism 540, according to embodiments of the present inventions. The RF-based encoding mechanism 550 may include M multi-level encoders (multi-level encoder 1 560a, multi-level encoder 2 560b, . . . , multi-level encoder m 560c) in the multi-level encoding mechanism 560 and M frequency division multiplexers (FDMs) (FDM 1 570a, FDM 2 570b, . . . , FDM m 570c) in the FDM mechanism 570. Correspondingly, the optical modulation mechanism 580 also includes M optimal modulators (optical modulator 1 580a, optical modulator 2 580b, . . . , optical modulator m 580c).

Each of the optical modulators takes an RF signal and up-converts the RF signal onto an optical carrier determined by an optical source with a different wavelength. An optical source 1 610a with wavelength λ₁ is used by the optical modulator 1 580a to convert an RF signal onto an optical carrier with wavelength λ₁. Similarly, an optical source 1 610a with wavelength λ₂ is used by the optical modulator 2 580b to convert an RF signal onto an optical carrier with wavelength λ₂, etc.

The content data comprising multiple data streams may be divided into M groups, each of which includes N data streams. The first group of N data streams is processed by the multi-level encoder 1 560a, the FDM 1 570a, and the optimal modulator 1 580a. The multi-level encoder 1 560a modulates the N data streams and generates K modulated signals. Here, K is not necessarily equal to N. That is, the multi-level encoder 1 560a may combine more than one data streams into a single modulated signal. The output of each of the pipelines produces an optical signal carried on a particular optical carrier at a certain wavelength. So, similarly, the second group of N data streams is processed by the multi-level encoder 560b, the FDM 2 570b, and the optical modulator 2 580b and the pipeline produces an optical signal carried by an optical carrier of a different wavelength.

If a particular optical carrier is dedicated to one or more head ends, any content that is intended for those head ends may be routed (by the switching matrix 535) to appropriate pipelines. For example, it is shown in FIG. 6 that one of the pipelines (the first one) produces an optical carrier with wavelength λ_{B} that is dedicated to carry broadcast content (for all head ends). The remaining optical carriers with wavelengths (λ₁, . . . , λ_{M}) may be dedicated for content that are sent based on demand. In this case, broadcast content is routed to the first pipeline and content on demand is routed to other pipelines according to which head end(s) the content is intended. Other arrangements are also possible. As discussed earlier, broadcast content may also be routed to all pipelines so that broadcast content will be carried by every optical carrier to ensure that all head ends can receive the content. In addition, some content may be routed directly to appropriate optical modulator(s) (now shown in FIG. 5). Finally, different optical carriers generated by different pipelines are multiplexed by the WDM 590 to produce a single optical signal.

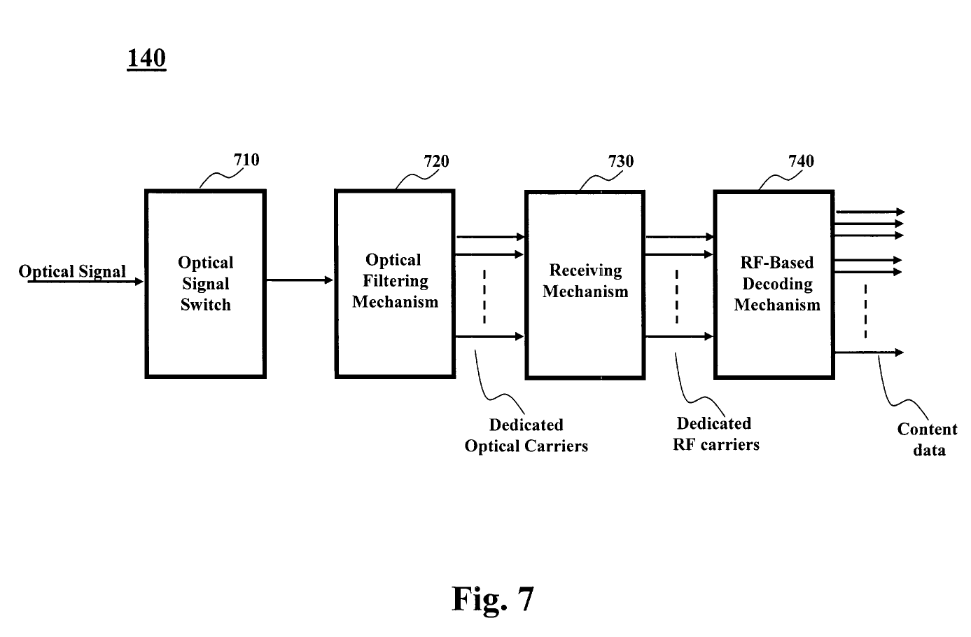

FIG. 7 depicts an exemplary block diagram of a head end (e.g., 140), according to embodiments of the present inventions. With the above-described various content distribution frameworks (100, 200, 300, and 400), a head end in any of such configurations is equipped to be capable of receiving content that is sent to the head end in an optical channel from a consolidated information distribution center (either the CIDC 120 or the CIDC 210) via an optical fiber, wherein the content is carried by one or more dedicated optical carriers.

To receive content encoded in the dedicated optical carrier(s), the head end 140 comprises, but is not limited to, an optical signal switch 710, an optical filtering mechanism 720, a receiving mechanism 730, and an RF-based decoding mechanism 740. The optical signal switch 710 is responsible for switching the head end to receive the optical signal from one of CIDCs, if the head end is connected to more than one CIDCs (e.g., an additional one may be provided for fault tolerance). The output of the optical signal switch 710 is an optical signal received from a consolidated information distribution center.

The optical filtering mechanism 720 takes the optical signal and filters the optical signal to obtain one or more optical channel dedicated to the head end. The receiving mechanism 730 then down-converts each of the dedicated optical channels to its corresponding dedicated RF/microwave carriers carrying a plurality of RF signals. Finally, the RF-based decoding mechanism 740 decodes or demodulates the RF signals to generate (or recover) the content data intended for the head end.

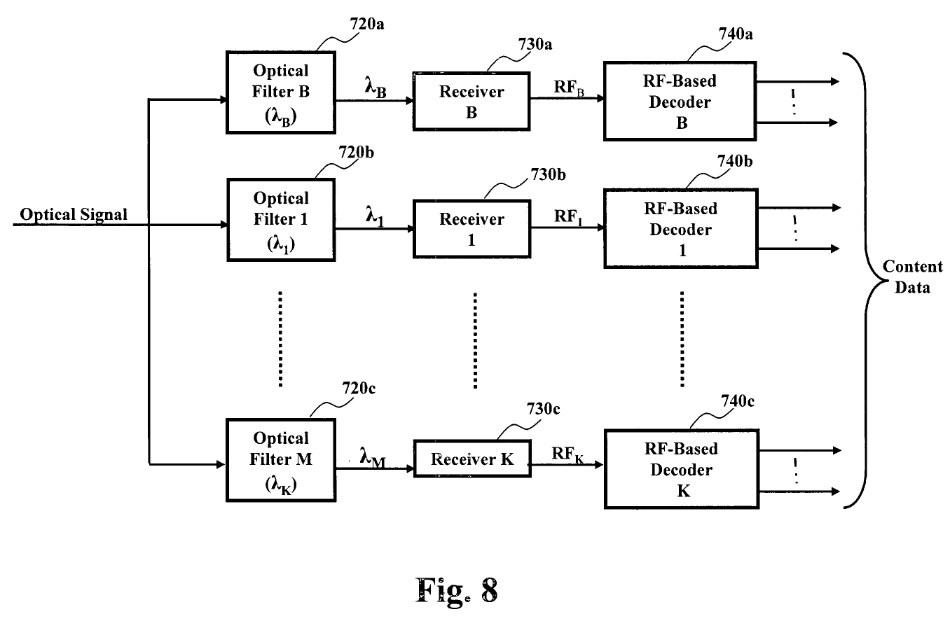

FIG. 8 depicts the internal block diagram of the optical filtering mechanism 720, the receiving mechanism 730, and the RF-based decoding mechanism 740 and their relationships, according to an embodiment of the present invention. The optical filtering mechanism 720 comprises one or more optical filters (an optical filter B 720a, an optical filter 1 720b, . . . , and an optical filter K 720c), each of which is tuned to a particular wavelength and is capable of filtering the optical signal so that only one optical channel whose wavelength matches the wavelength of the optical filter can go through the filter. Since only certain optical channels may be dedicated to a head end, the head end may comprise only the devices that are tuned to the dedicated optical channels.

The receiving mechanism 730 includes a plurality of receivers (a receiver B 730a, a receiver 1 730b, . . . , a receiver M 730c), each of which takes an optical channel with a particular wavelength and down-converts the optical channel to a corresponding RF signal with a particular frequency. For instance, the receiver B 730a takes an optical channel with wavelength λ_{B} (output of the optical filter B 720a) and down-converts it to an RF signal with frequency RF_{B}.

The RF-based decoding mechanism 740 includes a plurality of RF-based decoders (an RF-based decoder B 740a, an RF-based decoder 1 740b, . . . , an RF-based decoder 740c), each of which takes an RF channel of a particular frequency and demodulates the RF signals carried by the RF carrier to generate the original content data. For example, the RF-based decoder 740a takes the RF carrier with frequency RF_{B} and generates content corresponding to certain channels.

The optical filter B 720a, the receiver B 730a, and the RF-based decoder B 740a form a pipeline to decode the content encoded in the optical carrier with wavelength λ_{B}. Similarly, other pipelines correspond to different wavelengths. For instance, the pipeline formed by the optical filter 1 720b, the receiver 730b, and the RF-based decoder 740b is tuned to the optical carrier with wavelength λ₁. The pipeline formed by the optical filter 1 720b, the receiver 730b, and the RF-based decoder 740b is tuned to the optical carrier with wavelength λ_{K}. The number of pipelines needed for each head end may vary, depending on how many optical carriers are dedicated to the head end. For instance, if only two optical carriers (e.g., one for broadcast content and the other for video on demand) are dedicated to a head end, only two pipelines are needed (the first pipeline plus another pipeline tuned to the wavelength that matches with the dedicated optical carrier for non-broadcast content).

In FIG. 8, it is shown that one of the first decoding pipelines (formed by the optical filter B 720a, the receiver B 730a, and the RF-based decoder B 740a) is tuned to the optical carrier with wavelength λ_{B} dedicated to carry broadcast content. Other decoding pipelines tuned to wavelengths (λ₁, . . . , λ_{K}) are dedicated to non-broadcast content (e.g., content from a video server). Other schemes may also be implemented, as discussed earlier. For instance, broadcast content may be alternatively routed and carried by all optical carriers.

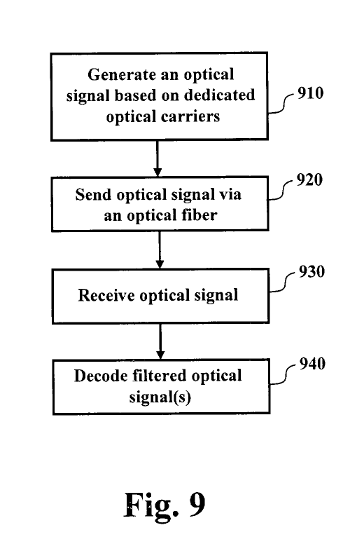

FIG. 9 is a flowchart of an exemplary process, in which a consolidated content delivery framework (e.g., 100, 200, 300, and 400) sends an optical signal carrying content data of multiple channels to a plurality of head ends via one or more optical fibers, according to embodiments of the present inventions. An optical signal is first generated at 910. During generating the optical signal, the content is routed to certain carriers according to the destination of the content. In addition, when a second CIDC (e.g., 210) is deployed, two optical signals may be individually generated at each CIDC based on the same content.

The generated optical signal is sent, at 920, to a plurality of head ends via an optical fiber. In the framework 300 with a star configuration, the optical signal may be sent to the head ends via more than one optical fiber. In the framework 400 with a ring configuration, the optical signal may be sent to the head ends via an optical fiber in different (opposite) directions. When a second CIDC (e.g., 210) is used for fault tolerance, both CIDCs (e.g., 120 and 210) may synchronously send optical signals individually generated by each to the head ends.

When each head end receives, at 930, the optical signal sent from a CIDC (each head end may receive one optical signal, from either of the CIDCs when two CIDCs are deployed) and transported by an optical fiber, it decodes, at 940, the optical carrier(s) that have been filtered (so that only the optical carriers dedicated to the head end is received) to recover the content data intended for the head end.

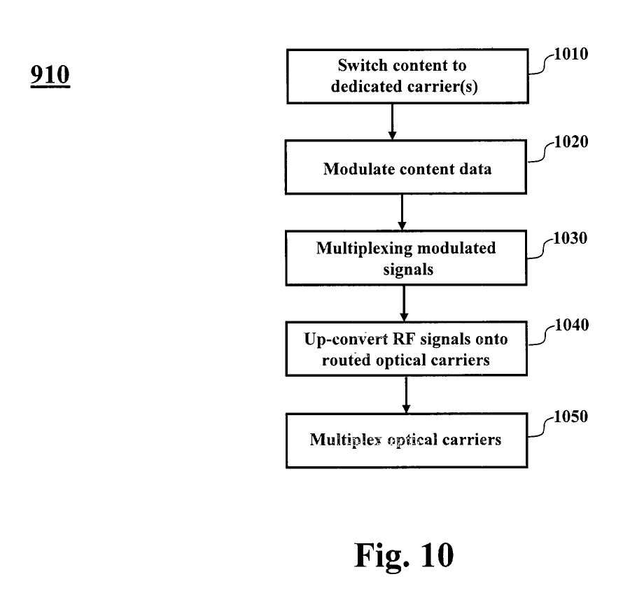

FIG. 10 is a flowchart of an exemplary process, in which a consolidated information distribution center (e.g., the CIDC 120) encodes content data to generate a single optical signal, according to embodiments of the present invention. Content intended for individual head ends is first routed, at 1010, to appropriate carriers. Such carriers may include both RF carriers and optical carriers. Data streams routed by appropriate pipelines are modulated at 1020 to produce modulated signals. The modulated signals are then multiplexed, at 1030, into one or more RF signals carried by RF carriers. The RF signals carried by the RF carriers are up-converted, at 1040, onto one or more optical carriers, which are then multiplexed, at act 1050, into a single optical signal.

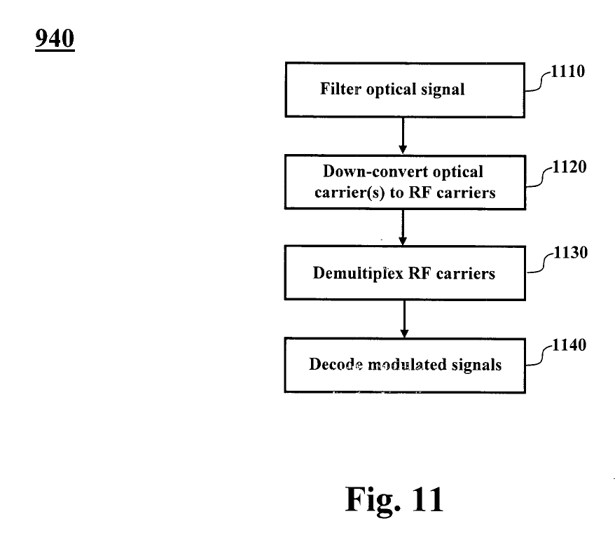

FIG. 11 is a flowchart of an exemplary process, in which a head end decodes an optical signal, received from a consolidated information distribution center via an optical fiber, to generate content data intended for the head end, according to embodiments of the present invention. The optical signal is first filtered at 1110. Since the filtering mechanism in each head end is tuned to only the wavelength(s) corresponding to optical carrier(s) dedicated to the head end, the filtering yields the optical carrier(s) carrying the content intended for the head end. To decode the content for the head end, the dedicated optical carriers are down-converted, at 1120, to corresponding RF carriers. Such RF carriers are further demultiplexed, at 1130, to generate modulated signals, which are then decoded, at 1140, to recover the content intended for the head end.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A consolidated information distribution system, comprising:
a consolidated information distribution center capable of sending an optical signal and aggregating signals carried on a plurality of dedicated optical channels via at least one optical fiber that transports the optical signal; and
at least one head end, each of which capable of receiving the optical signal and obtaining content, intended for the head end, carried on one or more of the optical carriers that are dedicated to the head end.

2. The consolidated information distribution system according to claim 1, wherein the at least one head end and the consolidated information distribution center is arranged in a linear configuration in which the at least one head end is arranged in a serial fashion and the optical signal is transported from the consolidated information distribution center to the at least one head end in a direction from a first head end to a last head end.

3. The consolidated information distribution system according to claim 2, further comprising a second consolidated information distribution center connecting to the at least one head end arranged in the serial fashion via the at least one optical fiber, wherein the optical signal is transported from the second consolidated information distribution center to the at least one head end in a direction from the last head end to the first head end.

4. The consolidated information distribution system according to claim 1, wherein the at least one head end and the consolidated information distribution center is arranged in a star configuration in which the optical signal from the consolidated information distribution center is transported via the at least one optical fiber directly to every head end of the at least one head end.

5. The consolidated information distribution system according to claim 4, further comprising a second consolidated information distribution center connecting to the at least one head end in the star configuration via at least one optical fiber, wherein the optical signal from the second consolidated information distribution center is transported directly to every head end of the at least one head end.

6. The consolidated information distribution system according to claim 1, wherein the at least one head end and the consolidated information distribution center is arranged in a ring configuration in which the at least one head end is aranged in a circular fashion, wherein the optical signal from the consolidated information distribution center is transported to the at least one head end in both a first direction from a first head end to a last head end and a second direction from the last head end to the first head end.

7. The consolidated information distribution system according to claim 1, wherein the consolidated information distribution center comprises at least one of:
a satellite farm capable of receiving content data from a satellite; and
a video server capable of providing digital content data; and
a switching matrix capable of switching the content data from both the satellite farm and the video server onto the plurality of dedicated signal channels.

8. The consolidated information distribution system according to claim 7, wherein the signal channels include at least one of an RF/microwave signal and an optical signal.

9. The consolidated information distribution system according to claim 8, wherein the switching matrix switches the content data from a satellite onto a signal channel that is dedicated to broadcast the content data from a satellite to all of the at least one head end.

10. The consolidated information distribution system according to claim 8, wherein the switching matrix switches the content data from a satellite onto all the signal channels.

11. The consolidated information distribution system according to claim 8, wherein the switching matrix switches the digital content data, requested by a user through a head end serving the user, onto one or more signal channels that are dedicated to the head end.

12. The consolidated information distribution system according to claim 8, further comprising an optical signal generation mechanism capable of generating the optical signal based on the content data.

13. The consolidated information distribution system according to claim 12, wherein the optical signal generation mechanism includes:
a radio frequency (RF) based encoding mechanism, capable of modulating the content data of multiple channels onto one or more dedicated RF/microwave carriers to produce corresponding one or more RF signals;
at least one optical modulator capable of up-converting the RF/microwave carriers carrying the RF signals onto the corresponding dedicated optical carriers carrying optical signals; and
a wavelength division multiplexer capable of combining the dedicated optical carriers to produce the optical signal.

14. The consolidated information distribution system according to claim 13, wherein each RF based encoding mechanism comprises:
a multi-level encoder capable of modulating content data of at least one channel to produce at least one modulated signal; and
a frequency division mulplexer capable of multiplexing a plurality of modulated signals, produced by a corresponding multi-level encoder, onto an RF/microwave carrier to produce a single RF signal.

15. The consolidated information distribution system according to claim 3, wherein each head end comprises:
an optical filtering mechanism capable of filtering the optical signal to obtain one or more optical carriers that are dedicated to the head end;
a receiving mechanism capable of down-converting the one or more optical carriers to produce a plurality of corresponding RF carriers carrying RF signals; and
an RF based decoding mechanism capable of decoding the RF signals to produce multiple data channels.

16. The consolidated information distribution system according to claim 15, wherein the optical filtering mechanism comprises a plurality of optical filters, each of which is capable of filtering the optical signal to obtain an optical signal carried by an optical carrier of a different wavelength.

17. The consolidated information distribution system according to claim 15, wherein the receiving mechanism comprises a plurality of receivers, each of which is capable of down-converting an optical signal carried by an optical carrier of a wavelength into an RF signal carried by an RF/microwave carrier of a frequency.

18. The consolidated information distribution system according to claim 15, wherein the RF-based decoding mechanism comprises a plurality of RF-based decoders, each of which is capable of demodulating an RF signals carried by an RF/microwave carrier.

19. The consolidated information distribution system according to claim 15, further comprising an optical signal switching mechanism capable of switching the head end to receive the optical signal via an optical fiber from one of the consolidated information distribution center and the second consolidated information distribution center.

20. A consolidated information distribution center capable of sending an optical signal to at least one head end via at least one optical fiber, comprising:
at least one content source providing content data;
a switching matrix capable of switching the content data onto at least one of a plurality of dedicated signal channels; and
an optical signal generation mechanism capable of generating an optical signal based on the content data using the plurality of dedicated signal channels.

21. The consolidated information distribution center according to claim 20, wherein the at least one content source includes at least one of:
a satellite farm capable of receiving content data from a satellite; and
a video server capable of providing digital content data.

22. The consolidated information distribution center according to claim 20, wherein the signal carriers include at least one of an RF/microwave carrier and an optical carrier.

23. The consolidated information distribution center according to claim 22, wherein the optical signal generation mechanism includes:
a radio frequency (RF) based encoding mechanism, capable of modulating the content data of multiple channels onto one or more dedicated RF/microwave carriers to produce corresponding one or more RF signals;
at least one optical modulator capable of up-converting the RF/microwave carriers carrying the RF signals onto the corresponding dedicated optical carriers carrying optical signals; and
a wavelength division multiplexer capable of combining the dedicated optical carriers to produce the optical signal.

24. The consolidated information distribution center according to claim 23, wherein each RF based encoding mechanism comprises:
at least one multi-level encoders, each of which capable of modulating content data of one or more channels to produce one or more modulated signals; and
at least one frequency division mulplexer, each of which capable of multiplexing a plurality of modulated signals, produced by a corresponding multi-level encoder, onto an RF/microwave carrier to produce a single RF signal.

25. A head end, comprising:
an optical filtering mechanism capable of filtering an optical signal, received from a consolidated information distribution center, to obtain one or more optical channels of different wavelengths that are dedicated to the head end;
a receiving mechanism capable of down-converting the one or more optical channels to produce a plurality of corresponding RF signals; and
an RF based decoding mechanism capable of decoding the RF signals to produce content data of multiple channels.

26. The head end according to claim 25, wherein the optical filtering mechanism comprises a plurality of optical filters, each of which is capable of filtering the optical signal to obtain an optical signal carried by a wavelength channel.

27. The head end according to claim 25, wherein the receiving mechanism comprises a plurality of receivers, each of which is capable of down-converting an optical channel into corresponding RF signals.

28. The head end according to claim 25, wherein the RF-based decoding mechanism comprises a plurality of RF-based decoders, each of which is capable of demodulating an RF signal to produce content data.

29. A method of distributing information, comprising:
generating, by a consolidated information distribution center, an optical signal encoded with content data of multiple channels carried by a plurality of optical carriers of different wavelengths, wherein at least some of the content data is carried by one or more dedicated optical carriers;
sending the optical signal to at least one head end via at least one optical fiber;
receiving, by the at least one head end, the optical signal that is transported through the at least one optical fiber; and
decoding, by each of the at least one head end, the optical signal to obtain content, intended for the at least one head end, from at least one optical carrier that is dedicated to carry the content for the at least one head end.

30. The method according to claim 29, wherein the generating comprises:
switching the content data of multiple channels to at least one dedicated carrier;
encoding the content data using the at least one dedicated carriers.

31. The method according to claim 30, wherein the at least one dedicated carrier includes at least one of:
one or more RF/microwave carriers of different frequencies; and
one or more optical carriers of different wavelengths.

32. The method according to claim 30, wherein the encoding comprises:
modulating the content data of multiple channels to produce one or more modulated signals;
multiplexing the one or more modulated signals onto the one or more RF/microwave carriers to produce one or more RF signals, each of which is carried by one of the RF/microwave carriers;
up-converting the one or more RF/microwave carriers carrying the RF signals onto the one or more optical carriers; and
multiplexing the one or more optical carriers to produce the optical signal.

33. The method according to claim 29, wherein the decoding comprises:
filtering, by each of the at least one head end, the optical signal to obtain one or more optical channels dedicated to the at least one head end;
down-converting the one or more optical channels to one or more RF/microwave carriers that carry RF signals;
demultiplexing the RF signals to produce modulated signals; and
decoding the modulated signals to produce the content data of multiple channels.

34. The method according to claim 29, further comprising switching, prior to the receiving, to receive the optical signal from a second consolidated information distribution center.

35. A method for a consolidated information distribution center, comprising:
switching content data of multiple channels to at least one dedicated carrier;
encoding the content data using the at least one dedicated carriers to produce an optical signal; and
sending the optical signal to at least one head end via at least one optical fiber.

36. The method according to claim 35, wherein the at least one dedicated carrier includes at least one of:
one or more RF/microwave carriers of different frequencies; and
one or more optical carriers of different wavelengths.

37. The method according to claim 35, wherein the encoding comprises:
modulating the content data of multiple channels to produce one or more modulated signals;
multiplexing the one or more modulated signals onto the one or more RF/microwave carriers to produce one or more RF signals, each of which is carried by one of the RF/microwave carriers;
up-converting the one or more RF/microwave carriers carrying the RF signals onto the one or more optical carriers; and
multiplexing the one or more optical carriers to produce the optical signal.

38. A method for a head end, comprising:
receiving an optical signal sent from a consolidated information distribution center and transported through at least one optical fiber connecting to the head end;
filtering the optical signal to obtain one or more optical channels of different wavelengths that are dedicated to the head end; and
decoding the one or more optical channels to produce content data of multiple channels.

39. The method according to claim 38, wherein the decoding comprises:
down-converting the one or more optical channels to one or more RF/microwave carriers that carry RF signals;
demultiplexing the RF signals to produce modulated signals; and
decoding the modulated signals to produce the content data of multiple channels.

40. The method according to claim 38, further comprising switching, prior to the receiving, to receive the single optical signal from a second consolidated information distribution center.

41. An information distribution system, comprising:
a consolidated information distribution center in communication with a plurality of sources of information;
a first head end in optical communication with said consolidated information distribution center; and
a second head end in optical communication with said consolidated information distribution center; wherein
said consolidated information distribution center is constructed to direct a first signal to said first head end over an information channel dedicated to said first head end, and
said consolidated information distribution center is constructed to direct a second signal to said second head end over an information channel dedicated to said second head end.

42. The information distribution system according to claim 41, further comprising:
an optical transmission fiber between said consolidated information distribution center and said first and second head ends, wherein
said information channel dedicated to said first head end and said information channel dedicated to said second head end are different wavelength channels of a wavelength division multiplexed signal adapted to be transmitted through said optical transmission fiber.

43. A method of distributing information, comprising:
receiving a first string of information;
directing said first string of information to a first information channel that is dedicated to a first head end of an information distribution system;
receiving a second string of information; and
directing said second string of information to a second information channel that is dedicated to a second head end of said information distribution system.

44. The method of distributing information according to claim 43, further comprising receiving a request for information to be sent to said first head end, wherein said directing said first string of information is in response to said receiving a request for information to be sent to said first head end.

45. The method of distributing information according to claim 43, further comprising
receiving a broadcast string of information;
directing said broadcast string of information to a broadcast channel that is in communication with said first and said second head ends, wherein
said broadcast channel is a non-dedicated channel of information.

46. The method of distributing information according to claim 43, wherein said first and second information channels are two different wavelength channels in a wavelength division multiplexed optical transmission signal along at least a portion of its transmission path.

47. An article comprising a storage medium having stored thereon instructions for distributing information that, when executed by a machine, result in the following:
generating, by a consolidated information distribution center, an optical signal encoded with content data of multiple channels carried by a plurality of optical carriers of different wavelengths, wherein at least some of the content data is carried by one or more dedicated optical carriers;
sending the optical signal to at least one head end via at least one optical fiber;
receiving, by the at least one head end, the optical signal that is transported through the at least one optical fiber; and
decoding, by each of the at least one head end, the optical signal to obtain content, intended for the head end, from at least one optical carrier that is dedicated to carry the content for the head end.

48. The article according to claim 47, wherein the generating comprises:
switching the content data of multiple channels to at least one dedicated carrier;
encoding the content data using the at least one dedicated carriers.

49. The article according to claim 48, wherein the at least one dedicated carrier includes at least one of:
one or more RF/microwave carriers of different frequencies; and
one or more optical carriers of different wavelengths.

50. The article according to claim 48, wherein the encoding comprises:
modulating the content data of multiple channels to produce one or more modulated signals;
multiplexing the one or more modulated signals onto the one or more RF/microwave carriers to produce one or more RF signals, each of which is carried by one of the RF/microwave carriers;
up-converting the one or more RF/microwave carriers carrying the RF signals onto the one or more optical carriers; and
multiplexing the one or more optical carriers to produce the optical signal.

51. The article according to claim 47, wherein the decoding comprises:
filtering, by each of the head end, the optical signal to obtain one or more optical channels dedicated to the head end;
down-converting the one or more optical channels to one or more RF/microwave carriers that carry RF signals;
demultiplexing the RF signals to produce modulated signals; and
decoding the modulated signals to produce the content data of multiple channels.

52. The article according to claim 47, the instructions, when executed by a machine, further result in switching, prior to the receiving, to receive the optical signal from a second consolidated information distribution center.

53. An article comprising a storage medium having stored thereon instructions for a consolidated information distribution center that, when executed by a machine, result in the following:
switching content data of multiple channels to at least one dedicated carrier;
encoding the content data using the at least one dedicated carriers to produce an optical signal; and
sending the optical signal to at least one head end via at least one optical fiber.

54. The article according to claim 53, wherein the at least one dedicated carrier includes at least one of:
one or more RF/microwave carriers of different frequencies; and
one or more optical carriers of different wavelengths.

55. The article according to claim 53, wherein the encoding comprises:
modulating the content data of multiple channels to produce one or more modulated signals;
multiplexing the one or more modulated signals onto the one or more RF/microwave carriers to produce one or more RF signals, each of which is carried by one of the RF/microwave carriers;
up-converting the one or more RF/microwave carriers carrying the RF signals onto the one or more optical carriers; and
multiplexing the one or more optical carriers to produce the optical signal.

56. An article comprising a storage medium having stored thereon instructions for a head end that, when executed by a machine, result in the following:
receiving an optical signal sent from a consolidated information distribution center and transported through at least one optical fiber connecting to the head end;
filtering the optical signal to obtain one or more optical channels of different wavelengths that are dedicated to the head end; and
decoding the one or more optical channels to produce content data of multiple channels.

57. The article according to claim 56, wherein the decoding comprises:
down-converting the one or more optical channels to one or more RF/microwave carriers that carry RF signals;
demultiplexing the RF signals to produce modulated signals; and
decoding the modulated signals to produce the content data of multiple channels.

58. The article according to claim 56, further comprising switching, prior to the receiving, to receive the single optical signal from a second consolidated information distribution center.

59. An article comprising a storage medium having stored thereon instructions for distributing information that, when executed by a machine, result in the following:
receiving a first string of information;
directing said first string of information to a first information channel that is dedicated to a first head end of an information distribution system;
receiving a second string of information; and
directing said second string of information to a second information channel that is dedicated to said second head end of said information distribution system.

60. The article according to claim 59, the instructions, when executed by a machine, further result in receiving a request for information to be sent to said first head end, wherein said directing said first string of information is in response to said receiving a request for information to be sent to said first head end.

61. The article according to claim 59, the instructions, when executed by a machine, further result in:
receiving a broadcast string of information;
directing said broadcast string of information to a broadcast channel that is in communication with said first and said second head ends, wherein
said broadcast channel is a non-dedicated channel of information.

62. The article according to claim 59, wherein said first and second information channels are two different wavelength channels in a wavelength division multiplexed optical transmission signal along at least a portion of its transmission path.
